(19) United States
(12) Patent Application Publication
(10) Pub. No.: US 2014/0345970 A1
(43) Pub. Date: Nov. 27, 2014

(54) METHOD AND APPARATUS COMBINING FRONT END LOADER AND MAN LIFT

(71) Applicant: Paul Kevin Wick, Fargo, ND (US)

(72) Inventor: Paul Kevin Wick, Fargo, ND (US)

(21) Appl. No.: 14/283,838

(22) Filed: May 21, 2014

Related U.S. Application Data
(60) Provisional application No. 61/825,918, filed on May 21, 2013.

(51) Int. Cl. B66F 11/04

(52) U.S. Cl. CPC B66F 11/042
USPC 182/69.5; 182/63.1; 182/149; 29/428

(57) ABSTRACT

A combination front end loader and man lift. The front end loader includes an adjustable frame with front and rear portions that extend or retract with respect to each other. The front portion is supported by a first pair of wheels and said rear portion is supported by a second pair of wheels. Each wheel is independently driven and steered. The front end loader also includes an engine mounted on the rear portion of the frame. Incorporated into the vehicle is an electro-hydraulic assembly which enables extension and retraction of the adjustable frame. The assembly includes a sensor-responsive microprocessor controller, at least one hydraulic pump, at least one hydraulic drive motor and at least one valve network. The hydraulics control a man lift which attaches to the front of the loader. The man lift can be moved by the loader to a desired location and then raised.

This application claims benefit of provisional patent application 61/825,918, filed May 21, 2013 by the present inventor.

### BACKGROUND OF INVENTION

The present invention relates to front end loaders (LOADER), and more specifically to a portable man lift (LIFT) attachment for a front end loader that uses power from the loader to position and operate the lift.

Front end loaders are compact loaders that have a wide range of utility from agriculture to construction. The compact size, tight turning radius, and ease of handling are some of the features that make front end loaders attractive in a typical working environment. The generic use of these vehicles resides in scooping material into a bucket or scoop attached to angled lifting arms on the front end loader to be hauled from place to place. While the traditional function of these vehicles garner its own range of utility, front end loaders serve as a base upon which numerous attachments or accessories may be mounted to greatly increase its versatility. Some of these attachments include angled booms, backhoes, earth augers and utility forks.

Although a variety of attachments or accessories are available, there is scarcity of man lift attachments. Aerial platforms have been used to raise work personnel and/or lift materials to elevated locations. These platforms or lifts tend to be remote operated and comprise of three main assemblages. At the base is a chassis which typically includes wheels, a steering mechanism, drive motors, and self-contained Hydraulic units, a platform to carry personnel and/or material, and a system of link sets between the chassis and the platform, the link sets being the main mechanic for raising and lowering the platform via a main lift cylinder. It would be beneficial in the art to provide a lift device that can be used in conjunction with a front end loader as an attachment.

### DRAWINS—FIGURES

FIG. 1 shows an isometric view of the complete unit in operation with the man lift extended.

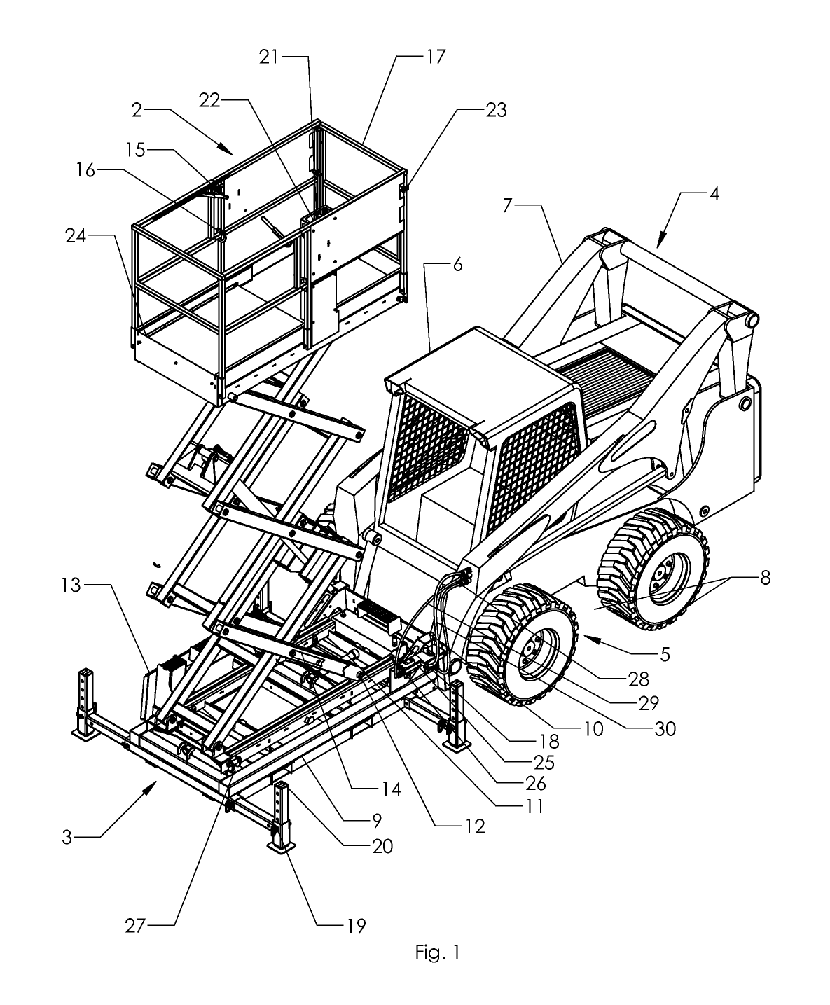

FIG. 2 shows an isometric view of the platform, surrounding railing, and operator controls.

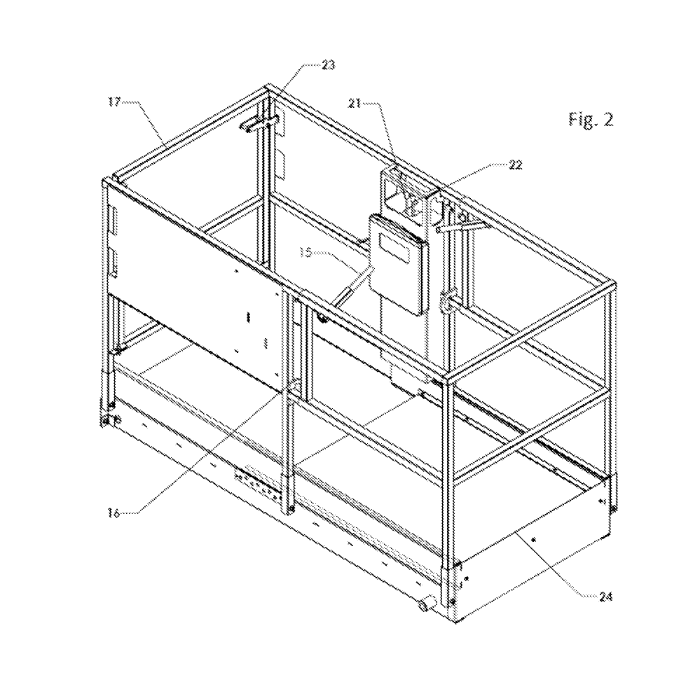

FIG. 3 shows an isometric view of the base of the man lift with the adjustable feet on the four corners.

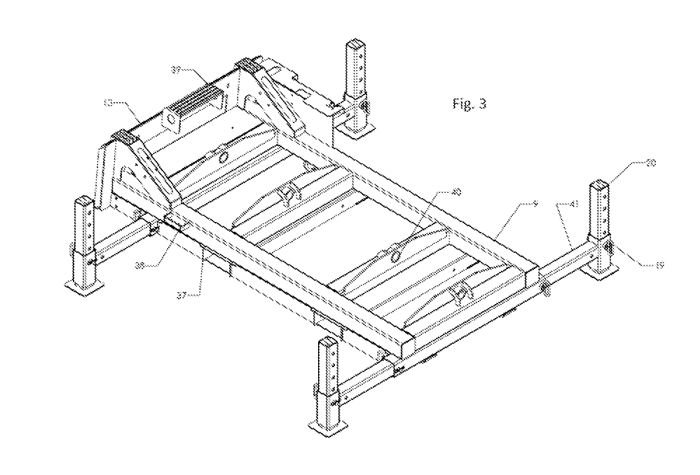

FIG. 4 shows the front end loader minus the man lift and minus the traditional bucket.

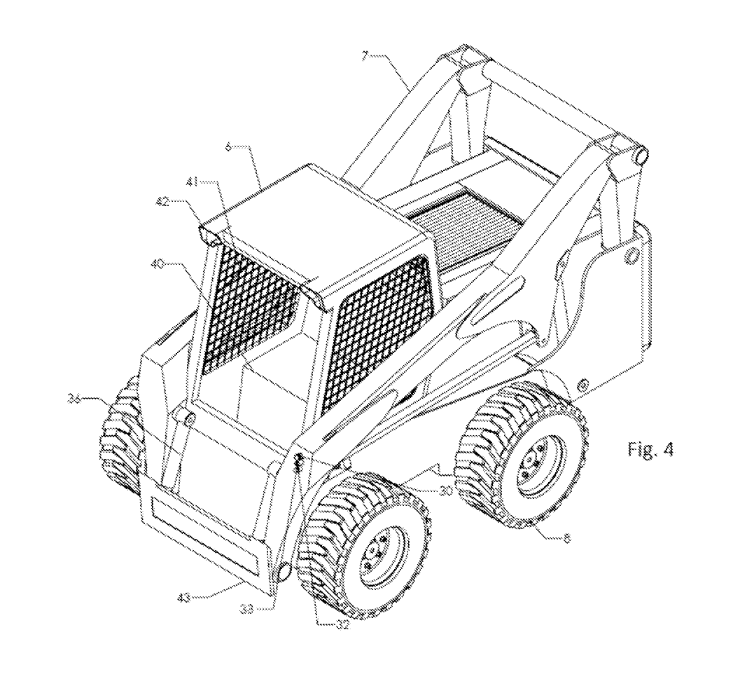

FIG. 5 is a close up view of the connection of the hydraulics from the front end loader to the man lift.

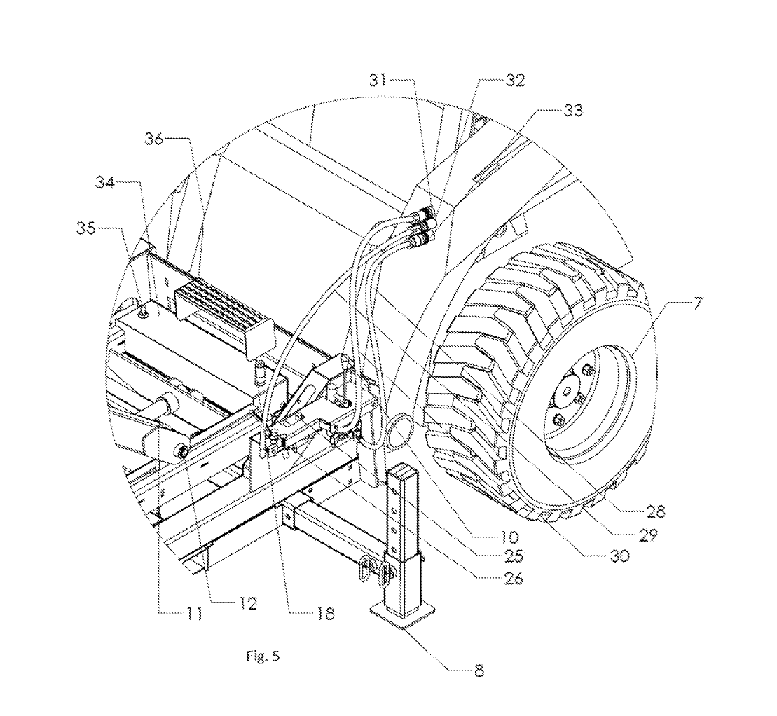

### DETAILED DESCRIPTION

The present invention comprises of two main units, the first being a front end loader or skid steer 4 (loader), and a second unit comprising a man lift 3. The front end loader 4 can be a typical industry front end loader. For use in this invention it must be able to lift and have hydraulic connections 31, 32, 33 for various attachments.

The second unit in the present invention comprises of three sub units. A base 9, linkages 14, and a platform 2. As an example, but not limited to, a scissors lift mechanisms 14 in general are known to the art. The principal purpose of such mechanisms is to provide a safe and efficient means for supporting a working platform 2 at any desired elevation. These lifts typically are comprised of a set of vertically linkages 14 that can be extended and are mounted on a frame 9 and are extended and a working platform 2 mounted on top of the linkages 14.

It is usual in the art for man lift mechanisms to provide a hydraulic drive cylinder mechanism 11 which is pivotally mounted to the frame 13, and which is coupled to a cross-bar extending between the lowermost pairs of arms of the linkages 14. The hydraulic lift mechanism serves to turn the arms of the lowermost pair about their pivotal axis to extend or retract the linkages and thereby to raise or lower the platform.

What the present invention overcomes is the need for the man lift 3 to be independently driven. Typically a man lift 3 has wheels attached to it base 9; the wheels are independently driven, towed or pushed by some other vehicle. In this embodiment of the invention the man lift's base has four feet 82 which are positioned on each of the four corners of the base 9. The entire man lift can 3 be raised or lowered by the loader 4, relocated to the desired location using the power of the loader 4, then the hydraulics of the loader are utilized to raise or lower the platform 2. When the lift is in operation the feet 82 provide for a solid support for the base 9 of the man lift 3. In one embodiment of this invention the feet 82 of the man lift are adjustable 19, 20 to allow the man lift 3 to be leveled when on uneven ground.

The loader arms 36 can be attached by fastening means directly to the man lift 3 or the font end loaders attachment plate 43. In another embodiment fork-lift tines are connected to the loader and can simply be slid under the base 9 of the man lift 3, the hydraulics connected 31 and the man lift 3 moved to where it needs to be used. In either case it is anticipated that the loaders hydraulics would power the man lift 3. It is also anticipated that the man lift 3 would have a control panel 15, 21, 22 on the platform 24 to control the elevating mechanism.

### METHOD

The loader 4 would approach the lift 3, attach the lift though the attachment plate 43 on the loader 4, or slide forklift tines under the lift 3, attach the hydraulics 28, 29, 30 on the lift 3 to the hydraulics 31, 32, 33 on the loader 3, then raise the lift 3 and use the loader 4 to move and position the lift 3 where needed. An operator can stand on the platform 2 of the lift 3 and use the control panel 15 to operate the lift hydraulics 10 thereby elevating the operator to the desired height.

### ADVANTAGES

This description in no way limits the configurations or equivalents of this patent. Much of the technology is known in the art and this description combines two well used tool (front end loader and man lift) however time has shown that designing a man lift with adjustable feet, allowing it to be operated and moved by a front end loader is not obvious in the art. This method and device lowers the cost of a man lift, and the size and maintenance required for a man lift.

I claim:

1. A combination man lift device comprising:
a) a front end loader attached by attaching means to;
b) a man lift.

2. The device of claim 1 further is including attaching the man lift to the front end loader by sliding fork-lift tines under the man lift and raising the arms of the loader.

3. The device of claim 1 further including connection of the man lifts hydraulics to the hydraulics of the loader.

4. The device of claim 3 further including the man lift operating through accordion linkages powered by the hydraulics.

5. The device of claim 1 where the man lift is supported by a base with multiple independent adjustable feet.

6. A man lift device comprising:
a) a base unit supported by a plurality of feet,
b) the feet being height adjustable,
c) an elevation unit utilizing accordion linkages,
d) where the linkages are powered by hydraulics,
e) and the linkages raise a work platform.

7. The device of claim 6 further including a front end loader whose attachment plate fastens to the device and uses the front end loaders hydraulics to power the man lift.

8. A method of attaching a man lift to a front end loader comprising:
a) attaching a man lift to a front end loader.

9. The method of claim 8 further including the man lift the type of accordion linkages powered by the loaders hydraulics and having a base with height adjustable feet.

10. The method of claim 9 further including:
a) positioning a front end loader for attachment to a man lift,
b) attaching the man lift to the front end loader,
c) lifting the man lift and positioning the man lift with the front end loader,
d) lowering the man lift to the ground,
e) leveling the man lift with the adjustable feet,
f) raising the platform of the man lift using the hydraulics of the front end loader.
